(19) United States
(12) Patent Application Publication
(10) Pub. No.: US 2025/0286391 A1
(43) Pub. Date: Sep. 11, 2025

(54) ELECTRONIC APPARATUS AND BATTERY PROTECTION METHOD THEREOF

(71) Applicant: ASUSTeK COMPUTER INC., Taipei City (TW)

(72) Inventors: Chunyen Lai, Taipei City (TW); Chun Tsao, Taipei City (TW); Wen-Che Chung, Taipei City (TW); Ying-Yui Wu, Taipei City (TW)

(73) Assignee: ASUSTeK COMPUTER INC., Taipei City (TW)

(21) Appl. No.: 19/056,774

(22) Filed: Feb. 19, 2025

(30) Foreign Application Priority Data
Mar. 6, 2024 (TW) 113108103

(51) Int. Cl. H02J 7/00; H01M 10/42; H01M 10/44; H01M 10/48

(52) U.S. Cl. CPC H02J 7/00309; H01M 10/425; H01M 10/443; H01M 10/486; H02J 7/0025; H02J 7/007182; H02J 7/007194; H01M 2010/4271; H01M 2200/10

(57) ABSTRACT

An electronic apparatus and a battery protection method thereof are provided. electronic apparatus includes a battery module, a charge control chip, and a controller. The battery module includes a battery cell pack and a control circuit. The control circuit is configured to detect and treat a temperature of the battery cell pack as a battery cell temperature and determines whether the battery module meets any one of a plurality of abnormal environmental conditions according to the battery cell temperature and stored power of the battery cell pack. When the battery module meets any one of the abnormal environmental conditions, the control circuit provides a corresponding recommended charging voltage reduction value. The charge control chip is configured to provide a charging voltage to the battery module. The controller is configured to obtain the recommended charging voltage reduction value and accordingly adjusts the charging voltage through the charge control chip.

### CROSS-REFERENCE TO RELATED APPLICATION

This application claims the priority benefit of Taiwan application serial no. 113108103, filed on Mar. 6, 2024. The entirety of the above-mentioned patent application is hereby incorporated by reference herein and made a part of specification.

### BACKGROUND

### Technical Field

The disclosure relates to an electronic apparatus capable of extending the service life of a battery cell and a battery protection method adopted therein.

### Description of Related Art

In today's handheld electronic products (e.g., laptops, mobile phones, digital cameras, or tablet computers), batteries play an important role in power supply. When a battery cell is operated in a high-charge or high-temperature and high-charge environment, the electrolyte solvent is likely to decompose and produce carbon dioxide gas, so it is easy to cause excessive gas to be generated inside the battery cell and cause the appearance to swell. Failure to immediately lower the charging voltage applied to the battery or remove the battery cell from the high-charge or high-temperature and high-charge environment in a timely manner may cause permanent damage to the battery and shorten its service life.

### SUMMARY

The disclosure provides an electronic apparatus including a battery module, a charge control chip, and a controller. The battery module includes a battery cell pack and a control circuit. The control circuit is coupled to the battery cell pack and is configured to detect and treat a temperature of the battery cell pack as a battery cell temperature and determines whether the battery module meets any one of a plurality of abnormal environmental conditions according to the battery cell temperature and stored power of the battery cell pack. When the battery module meets any one of the plurality of abnormal environmental conditions, the control circuit provides a corresponding recommended charging voltage reduction value. The charge control chip is coupled to the battery module and is configured to provide a charging voltage to the battery module. The controller is coupled to the battery module and the charge control chip, is configured to obtain the recommended charging voltage reduction value, and accordingly adjusts the charging voltage through the charge control chip.

The disclosure further provides a battery protection method suitable for an electronic apparatus including a battery module. The battery module includes a battery cell pack. The method includes the following steps. A temperature of the battery cell pack is detected and treated as a battery cell temperature. It is determined whether the battery module meets any one of a plurality of abnormal environmental conditions according to the battery cell temperature and stored power of the battery cell pack. When the battery module meets any one of the plurality of abnormal environmental conditions, a corresponding recommended charging voltage reduction value is provided. A charging voltage provided to the battery module is adjusted according to the recommended charging voltage reduction value.

To sum up, in the electronic apparatus and the battery protection method thereof provided by the disclosure, the charging voltage is able to be flexibly adjusted when the battery module is operated in an abnormal environment such as a high-charge or high-temperature and high-charge environment. As such, the battery cell pack is able to be separated from the high-charge or high-temperature and high-charge environment in time, and the probability of battery cell swelling is reduced. In this way, permanent damage to the battery module is prevented from occurring, so that its service life is extended.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic block diagram illustrating an electronic apparatus according to an embodiment of the disclosure.

FIG. 2 is a schematic circuit diagram illustrating a discharging circuit according to an embodiment of the disclosure.

FIG. 3 is a flow chart of steps illustrating a battery protection method according to an embodiment of the disclosure.

FIG. 4A is an example illustrating a first abnormal environmental condition according to an embodiment of the disclosure.

FIG. 4B is an example illustrating a second abnormal environmental condition according to an embodiment of the disclosure.

FIG. 5 is a schematic waveform graph illustrating a recommended charging voltage value according to an embodiment of the disclosure.

### DESCRIPTION OF THE EMBODIMENTS

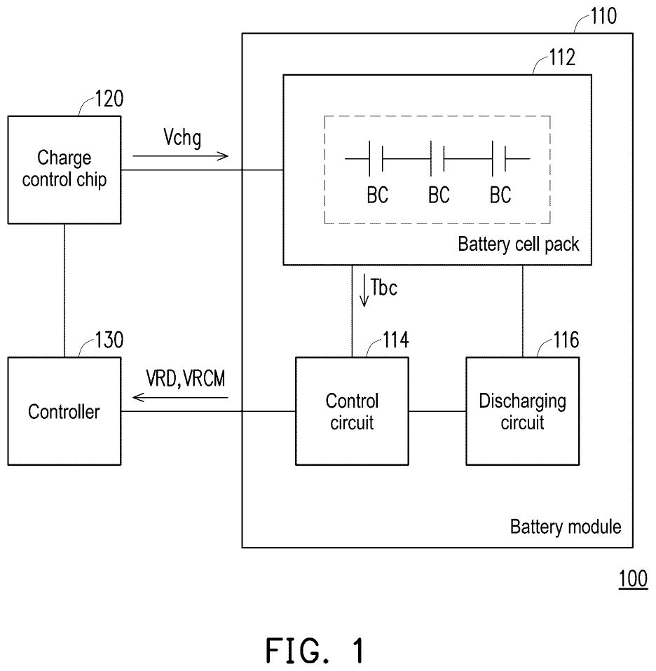

With reference to FIG. 1, an electronic apparatus 100 of this embodiment is a handheld electronic product such as a notebook computer, a mobile phone, a digital camera, a tablet computer, etc. The electronic apparatus 100 includes a battery module 110, a charge control chip 120, and a controller 130.

The battery module 110 may be used to power the electronic apparatus 100 and may be a built-in module or an external module. The battery module 110 includes a battery cell pack 112, a control circuit 114, and a discharging circuit 116. The battery cell pack 112 includes a plurality of battery cells (battery cell units) BC connected in series and may be charged via a charging voltage Vchg. The charging voltage Vchg is, for example, the voltage applied to positive and negative electrodes of the battery module 110.

The control circuit 114 is, for example, a battery gauge chip (battery gauge IC) or a microcontroller. The control circuit 114 is coupled to the battery cell pack 112 and may detect and treat a temperature of the battery cell pack 112 as a battery cell temperature Tbc through, for example, a temperature sensor disposed inside the battery module 110. Further, the control circuit 114 may also detect the charging voltage Vchg received by the battery cell pack 112 and a voltage of each battery cell BC in the battery cell pack 112 and calculates stored power and a battery cell voltage of the battery cell pack 112. The stored power of the battery cell pack 112 may be calculated through, for example, an open circuit voltage method, a coulomb measurement method, or a dynamic voltage algorithm gauge. The battery cell voltage of the battery cell pack 112 is, for example, equal to a voltage difference between the positive and negative electrodes of the battery module 110.

The discharging circuit 116 is coupled to the control circuit 114 and the plurality of battery cells BC and may be used to support a self-discharging function. When the self-discharging function is turned on, the control circuit 114 may establish one or a plurality of discharging loops through the discharging circuit 116, so that the plurality of battery cells BC are discharged sequentially.

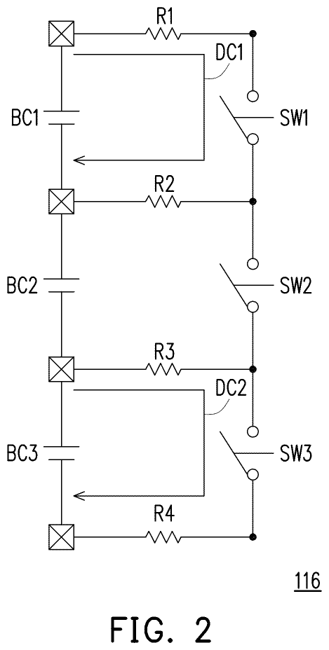

The discharging circuit 116 may include a plurality of switches connected in series and a plurality of resistors coupled between ends of the corresponding switches and ends of the corresponding battery cells BC. For instance, the plurality of battery cells BC of the battery cell pack 112 include a first battery cell BC1, a second battery cell BC2, and a third battery cell BC3 connected in series. With reference to FIG. 2, in the discharging circuit 116, a first resistor R1 is coupled between a first end of the first battery cell BC1 and a first end of a first switch SW1. A second resistor R2 is coupled between a first end of the second battery cell BC2 and a first end of a second switch SW2. A third resistor R3 is coupled between a first end of the third battery cell BC3 and a first end of a third switch SW3. A fourth resistor R4 is coupled between a second end of the third battery cell BC3 and a second end of the third switch SW3. In this embodiment, the first switch SW1 to the third switch SW3 are controlled to be turned on or off according to a control signal from the control circuit 114.

When the self-discharging function is turned on, the control circuit 114 may turn on one or more of the first switch SWI to the third switch SW3 to establish one or more discharging loops. For instance, when the self-discharging function is turned on, the control circuit 114 may detect the voltages of the first battery cell BC1 to the third battery cell BC3. If the voltage of the first battery cell BC1 is the highest and is higher than the voltage of the battery cell with the lowest voltage by a predetermined voltage (e.g., 5 millivolts), the control circuit 114 may turn on the first switch SW1 to establish a discharging loop DC1 formed by the first resistor R1, the first switch SW1, and the second resistor R2, so that the first battery cell BC1 may perform self-discharging. If the voltage of the third battery cell BC3 is the highest and is higher than the voltage of the battery cell with the lowest voltage by the predetermined voltage (e.g., 5 millivolts), the control circuit 114 may turn on the third switch SW3 to establish a discharging loop DC2 formed by the third resistor R3, the third switch SW3, and the fourth resistor R4, so that the third battery cell BC3 may perform self-discharging. The rest may be deduced by analogy until the self-discharging function is turned off. Further, the control circuit 114 may also turn on the corresponding switches sequentially or simultaneously according to the voltage of each battery cell among the first battery cell BC1 to the third battery cell BC3, so that the first battery cell BC1 to the third battery cell BC3 are discharged sequentially.

It should be noted that in other embodiments, in addition to the self-discharging function, each battery cell BC may also be discharged through other methods (such as unplugging an AC adapter from the electronic apparatus 100 to maintain the battery cell pack 112 in a continuous discharging state), which is not limited by the disclosure.

In FIG. 1, the charge control chip 120 is coupled to the battery module 110. The charge control chip 120 is, for example, a charger chip (charger IC), which may be used to receive a power source and convert the power source into the charging voltage Vchg to be provided to the battery module 110. The power source may be wired power (e.g., from an AC adapter) or wireless power (e.g., from any wireless power bank device).

The controller 130 is coupled to the battery module 110 and the charge control chip 120. The controller 130 is, for example, a programmable chip such as an embedded controller (EC) or a microcontroller that can communicate with the battery module 110 through a communication protocol. The communication protocol is, for example, a system management bus (SMBus) or an inter-integrated circuit (I2C), but this embodiment is not limited thereto.

During the use of the battery module 110, the battery module 110 may be exposed to a high-temperature environment for a long time (for example, when a user is playing games, and in order to maintain high image quality, the overall temperature of the electronic apparatus 100 rises, or the electronic apparatus 100 is placed in a high-temperature environment by the user due to traveling, business trips, or usage needs), a high-charge environment for a long time (for example, when the battery cell pack 112 is fully charged, the electronic apparatus 100 is still plugged into the AC adapter for a long time without being unplugged, etc.), or a relatively high-temperature and high-charge environment for a long time (for example, the electronic apparatus 100 is plugged into the AC adapter for a long time to act as a wireless sharer). In this case, if the charging voltage Vchg received by the battery cell pack 112 cannot be immediately lowered or the battery cell pack 112 cannot be removed from the high-charge or high-temperature and high-charge environment in a timely manner, permanent damage may be caused to the battery module 110 and its service life may be shortened. Therefore, in this embodiment, the control circuit 114 may load stored firmware to turn on a battery intelligent maintenance mode and then execute the battery protection method provided by the disclosure. In this way, the battery cells BC are discharged sequentially, the charging voltage Vchg received by the battery cell pack 112 is lowered in a timely manner, the battery cells BC are separated from the high-charge or high-temperature and high-charge environment, and the user's power demand is satisfied.

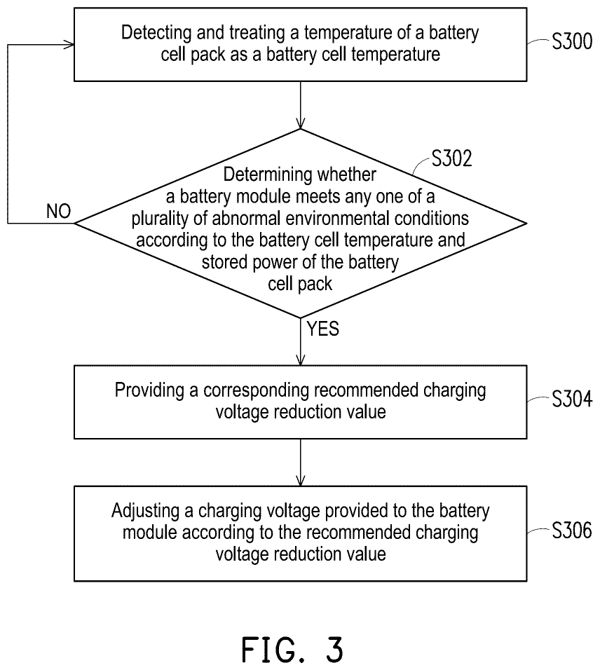

The following examples illustrate the detailed steps of the battery protection method of provided by the disclosure. With reference to FIG. 1 and FIG. 3 together, a battery protection method provided by this embodiment may be applied to the electronic apparatus 100 of FIG. 1, and the steps are described as follows:

First, in step S300, the control circuit 114 detects and treats the temperature of the battery cell pack 112 as the battery cell temperature Tbc.

Next, in step S302, the control circuit 114 determines whether the battery module 110 meets any one of a plurality of abnormal environmental conditions according to the battery cell temperature Tbc and the stored power of the battery cell pack 112. When the battery module 110 does not meet any abnormal environmental conditions, return to step S300 to continue detection.

When the battery module 110 meets any one of the plurality of abnormal environmental conditions, the control circuit 114 provides a corresponding recommended charging voltage reduction value VRD in step S304. In this way, the controller 130 may obtain the recommended charging voltage reduction value VRD from the control circuit 114. In step S306, the controller 130 adjusts the charging voltage Vchg provided to the battery module 110 according to the recommended charging voltage reduction value VRD through the charge control chip 120.

For instance, the plurality of abnormal environmental conditions include a first abnormal environmental condition and a second abnormal environmental condition. In this embodiment, the first abnormal environmental condition is that the stored power of the battery cell pack 112 is maintained at a full charge capacity for a first length of time Ltx. The full charge capacity is the state in which the power stored in the battery cell pack 112 is fully charged, that is, the relative state-of-charge (RSOC) is 100%.

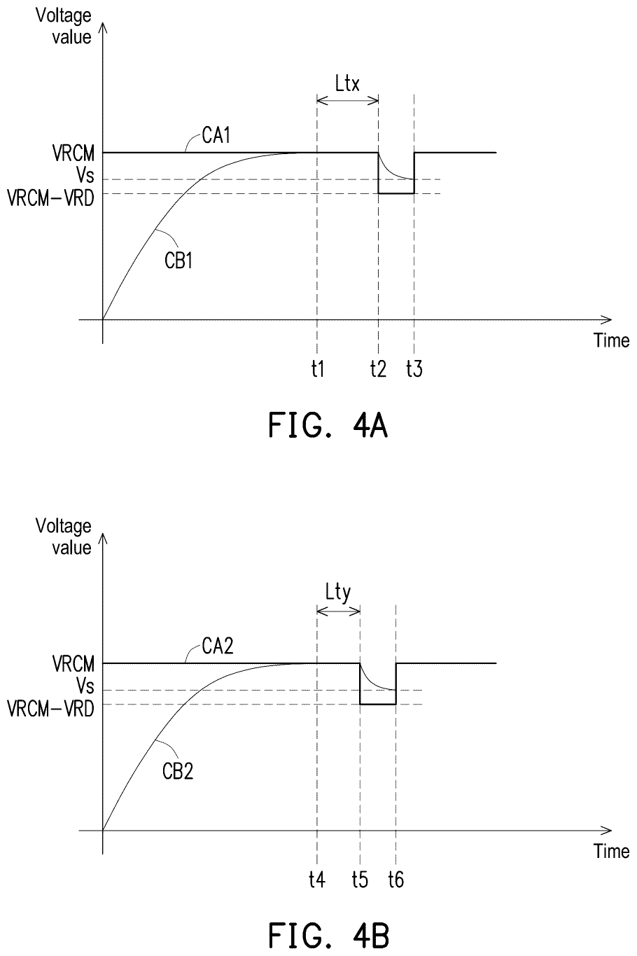

With reference to FIG. 4A, the vertical axis of FIG. 4A is the voltage value, and the horizontal axis is time. In FIG. 4A, a charging voltage curve CA1 representing a variation trajectory of the charging voltage Vchg and a battery cell voltage curve CB1 representing a variation trajectory of the battery cell voltage of the battery cell pack 112 are shown. As shown in FIG. 4A, during the use of the battery module 110, an initial value of the recommended charging voltage reduction value VRD is 0. The controller 130 may adjust the charging voltage Vchg to a received recommended charging voltage value VRCM through the charge control chip 120, so that the charging voltage curve CA1 is maintained at the recommended charging voltage value VRCM. The battery cell voltage curve CB1 may gradually approach the charging voltage curve CA1.

At a time point t1, the stored power of the battery cell pack 112 reaches the full charge capacity (the charging voltage curve CA1 overlaps the battery cell voltage curve CB1). The control circuit 114 may begin to accumulate the time that the stored power of the battery cell pack 112 remains at a full charge. When a time point t2 is reached after the first length of time Ltx, if the stored power of the battery cell pack 112 is still maintained at the full charge capacity, it means that the battery module 110 meets the first abnormal environmental condition. At this time, the control circuit 114 may provide the corresponding recommended charging voltage reduction value VRD to the controller 130.

The controller 130 may adjust the charging voltage Vchg provided to the battery module 110 according to the recommended charging voltage reduction value VRD through the charge control chip 120. Therefore, at the time point t2, the charging voltage curve CA1 drops to the recommended charging voltage value VRCM minus the recommended charging voltage reduction value VRD.

Due to the decrease in charging voltage Vchg (charging voltage curve CA1), the battery cell voltage of the battery cell pack 112 may be greater than the current charging voltage Vchg. Therefore, the control circuit 114 may turn on the self-discharging function to discharge the battery cells BC sequentially through, for example, the discharging circuit 116. At the same time, the battery cell voltage (battery cell voltage curve CB1) of the battery cell pack 112 may also decrease accordingly.

At a time point t3, since the battery cell voltage of the battery cell pack 112 drops to a safety voltage Vs, the stored power of the battery cell pack 112 may be less than a power threshold value (the power threshold value is, for example, 95% of the full charge capacity). At this time, the control circuit 114 may restore the provided recommended charging voltage reduction value VRD to 0, so that the charging voltage Vchg is restored to the recommended charging voltage value VRCM. As shown in FIG. 4A, at the time point t3, the charging voltage curve CA1 is restored to the recommended charging voltage value VRCM, and at the same time, the battery cell voltage (battery cell voltage curve CB1) of the battery cell pack 112 may also increase accordingly.

In addition, in this embodiment, the second abnormal environmental condition is that the stored power of the battery cell pack 112 is maintained at the full charge capacity and the battery cell temperature Tbc is greater than or equal to a temperature threshold value (the temperature threshold is set between 35 degrees Celsius and 40 degrees Celsius, for example) cumulatively reaching a second length of time Lty.

With reference to FIG. 4B, the vertical axis of FIG. 4B is the voltage value, and the horizontal axis is time. In FIG. 4B, a charging voltage curve CA2 representing the variation trajectory of the charging voltage Vchg and a battery cell voltage curve CB2 representing the variation trajectory of the battery cell voltage of the battery cell pack 112 are shown. As shown in FIG. 4B, during the use of the battery module 110, the initial value of the recommended charging voltage reduction value VRD is 0. The controller 130 may adjust the charging voltage Vchg to the received recommended charging voltage value VRCM through the charge control chip 120, so that the charging voltage curve CA2 is maintained at the recommended charging voltage value VRCM. The battery cell voltage curve CB2 may gradually approach the charging voltage curve CA2.

At a time point t4, the stored power of the battery cell pack 112 reaches the full charge capacity (the charging voltage curve CA2 overlaps the battery cell voltage curve CB2), and the battery cell temperature Tbc is greater than or equal to the temperature threshold value. The control circuit 114 may begin to accumulate the time during which the stored power of the battery cell pack 112 is maintained at the full charge capacity and the battery cell temperature Tbc is greater than or equal to the temperature threshold value. When a time point t5 is reached after the second length of time Lty, if the stored power of the battery cell pack 112 is still maintained at the full charge capacity and the battery cell temperature Tbc is greater than or equal to the temperature threshold value, it means that the battery module 110 meets the second abnormal environmental condition. At this time, the control circuit 114 may provide the corresponding recommended charging voltage reduction value VRD to the controller 130.

The controller 130 may adjust the charging voltage Vchg provided to the battery module 110 according to the recommended charging voltage reduction value VRD through the charge control chip 120. Therefore, at the time point t5, the charging voltage curve CA2 drops to the recommended charging voltage value VRCM minus the recommended charging voltage reduction value VRD.

Due to the decrease in charging voltage Vchg (charging voltage curve CA2), the battery cell voltage of the battery cell pack 112 may be greater than the current charging voltage Vchg. Therefore, the control circuit 114 may turn on the self-discharging function to discharge the battery cells BC sequentially through, for example, the discharging circuit 116. At the same time, the battery cell voltage (battery cell voltage curve CB2) of the battery cell pack 112 may also decrease accordingly.

At a time point t6, since the battery cell voltage of the battery cell pack 112 drops to the safety voltage Vs, the stored power of the battery cell pack 112 may be less than the power threshold value (the power threshold value is, for example, 95% of the full charge capacity). At this time, the control circuit 114 may restore the provided recommended charging voltage reduction value VRD to 0, so that the charging voltage Vchg is restored to the recommended charging voltage value VRCM. As shown in FIG. 4B, at the time point t6, the charging voltage curve CA2 is restored to the recommended charging voltage value VRCM, and at the same time, the battery cell voltage (battery cell voltage curve CB2) of the battery cell pack 112 may also increase accordingly.

It should be noted that compared to the high-charge environment of the first abnormal environmental condition, the high-temperature and high-charge environment of the second abnormal environmental condition causes greater damage to the battery module 110. Therefore, the second length of time Lty corresponding to the second abnormal environmental condition is set to be less than the first length of time Ltx corresponding to the first abnormal environmental condition, so that the battery module 110 may escape from the dangerous environment faster. In addition, the recommended charging voltage reduction value VRD under the second abnormal environmental condition may also be different from the recommended charging voltage reduction value VRD under the first abnormal environmental condition.

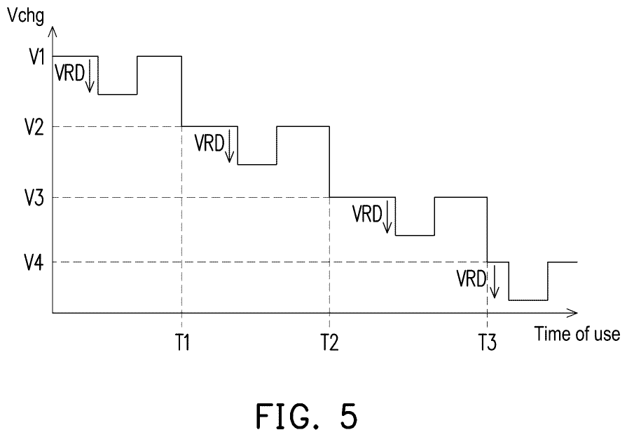

In an embodiment, during the use of the battery module 110, the control circuit 114 may sequentially reduce the recommended charging voltage value VRCM provided to the controller 130 in response to time of use of the battery module 110. With reference to FIG. 5, the vertical axis of FIG. 5 is the charging voltage Vchg, and the horizontal axis is the time of use of the battery module 110. For instance, when the time of use of the battery module 110 is within T1 (for example, within one year), the control circuit 114 may provide the recommended charging voltage value VRCM with a value V1 to the controller 130, so that the controller 130 may adjust the charging voltage Vchg to the value V1 through the charge control chip 120.

During the period when the time of use of the battery module 110 is within T1, when the battery module 110 meets a specific abnormal environmental condition, the control circuit 114 may provide the corresponding recommended charging voltage reduction value VRD to the controller 130. In this way, the controller 130 adjusts the charging voltage Vchg provided to the battery module 110 through the charge control chip 120 according to the current recommended charging voltage value VRCM (value V1) and the recommended charging voltage reduction value VRD. To be specific, as shown in FIG. 5, when the battery module meets a specific abnormal environmental condition, the controller 130 may adjust the charging voltage Vchg through the charge control chip 120 by further reducing the corresponding recommended charging voltage reduction value VRD based on the current recommended charging voltage value VRCM (value V1).

Next, after being no longer in this abnormal environmental condition (for example, the stored power of the battery cell pack 112 is less than the power threshold value), the control circuit 114 may restore the provided recommended charging voltage reduction value VRD to 0, so that the controller 130 may adjust and restore the charging voltage Vchg to the current recommended charging voltage value VRCM (value V1).

In addition, when the time of use of the battery module 110 is between T1 and T2 (for example, one to two years), the control circuit 114 may provide the recommended charging voltage value VRCM with a value of V2 to the controller 130. Therefore, the controller 130 may adjust the charging voltage Vchg to the value V2 through the charge control chip 120. When the time of use of the battery module 110 is T2 to T3 (for example, two to three years), the control circuit 114 may provide the recommended charging voltage value VRCM with a value V3 to the controller 130, so that the controller 130 may adjust the charging voltage Vchg to the value V3 through the charge control chip 120. When the time of use of the battery module 110 is T3 (for example, more than three years), the control circuit 114 may provide the recommended charging voltage value VRCM with a value V4 to the controller 130, so that the controller 130 may adjust the charging voltage Vchg to the value V4 through the charge control chip 120. In this embodiment, the value V1 is greater than the value V2, the value V2 is greater than the value V3, and the value V3 is greater than the value V4. In other words, the recommended charging voltage value VRCM may decrease step by step with the accumulation of the time of use of the battery module 110.

Similarly, when the battery module meets a specific abnormal environmental condition, the controller 130 may adjust the charging voltage Vchg through the charge control chip 120 by further reducing the corresponding recommended charging voltage reduction value VRD based on the current recommended charging voltage value VRCM (value V2, V3, or V4). Further, after being no longer in this abnormal environmental condition (for example, the stored power of the battery cell pack 112 is less than the power threshold value), the control circuit 114 may restore the provided recommended charging voltage reduction value VRD to 0, so that the controller 130 may adjust and restore the charging voltage Vchg to the current recommended charging voltage value VRCM (value V2, V3, or V4).

In view of the foregoing, in the electronic apparatus and the battery protection method thereof provided by the disclosure, the charging voltage may be flexibly adjusted when the battery module is operated in an abnormal environment such as a high-charge or high-temperature and high-charge environment. Further, after the battery cell pack is no longer in the high-charge or high-temperature and high-charge environment in a timely manner through the discharging technology of the battery module itself, the charging voltage may be restored to the current recommended charging voltage value. In this way, permanent damage to the battery module may be prevented from occurring, so that its service life can be extended, and power demand from the user may also be taken into account.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic apparatus, comprising:
a battery module comprising a battery cell pack and a control circuit, wherein the control circuit is coupled to the battery cell pack, is configured to detect and treat a temperature of the battery cell pack as a battery cell temperature, determines whether the battery module meets any one of a plurality of abnormal environmental conditions according to the battery cell temperature and stored power of the battery cell pack, and provides a corresponding recommended charging voltage reduction value when the battery module meets any one of the plurality of abnormal environmental conditions;
a charge control chip coupled to the battery module and configured to provide a charging voltage to the battery module; and
a controller coupled to the battery module and the charge control chip, configured to obtain the recommended charging voltage reduction value, and accordingly adjusts the charging voltage through the charge control chip.

2. The electronic apparatus according to claim 1, wherein the plurality of abnormal environmental conditions comprise a first abnormal environmental condition and a second abnormal environmental condition, the first abnormal environmental condition is that the stored power of the battery cell pack is maintained at a full charge capacity for a first length of time, and the second abnormal environmental condition is that the stored power of the battery cell pack is maintained at the full charge capacity and the battery cell temperature is greater than or equal to a temperature threshold value cumulatively reaching a second length of time.

3. The electronic apparatus according to claim 2, wherein the second length of time is less than the first length of time.

4. The electronic apparatus according to claim 1, wherein the control circuit sequentially reduces a recommended charging voltage value provided to the controller in response to usage time of the battery module.

5. The electronic apparatus according to claim 4, wherein during use of the battery module, the controller adjusts the charging voltage through the charge control chip by further reducing the corresponding recommended charging voltage reduction value based on the current recommended charging voltage value.

6. The electronic apparatus according to claim 5, wherein when the stored power of the battery cell pack is less than a power threshold value, the control circuit restores the provided recommended charging voltage reduction value to 0, so that the charging voltage is restored to the recommended charging voltage value.

7. The electronic apparatus according to claim 1, wherein when a battery cell voltage of the battery cell pack is greater than the charging voltage, the control circuit turns on a self-discharging function.

8. The electronic apparatus according to claim 7, wherein the battery cell pack comprise a plurality of battery cells connected in series, the battery module further comprises a discharging circuit coupled to the control circuit and the plurality of battery cells, and when the self-discharging function is turned on, the control circuit establishes one or a plurality of discharging loops through the discharging circuit, so that the plurality of battery cells are discharged sequentially.

9. A battery protection method suitable for an electronic apparatus comprising a battery module, wherein the battery module comprises a battery cell pack, and the battery protection method comprises:
detecting and treating a temperature of the battery cell pack as a battery cell temperature;
determining whether the battery module meets any one of a plurality of abnormal environmental conditions according to the battery cell temperature and stored power of the battery cell pack;
providing a corresponding recommended charging voltage reduction value when the battery module meets any one of the plurality of abnormal environmental conditions; and
adjusting a charging voltage provided to the battery module according to the recommended charging voltage reduction value.

10. The battery protection method according to claim 9, wherein the plurality of abnormal environmental conditions comprise a first abnormal environmental condition and a second abnormal environmental condition, the first abnormal environmental condition is that the stored power of the battery cell pack is maintained at a full charge capacity for a first length of time, and the second abnormal environmental condition is that the stored power of the battery cell pack is maintained at the full charge capacity and the battery cell temperature is greater than or equal to a temperature threshold value cumulatively reaching a second length of time.

11. The battery protection method according to claim 10, wherein the second length of time is less than the first length of time.

12. The battery protection method according to claim 9, further comprising:
sequentially reducing a recommended charging voltage value in response to usage time of the battery module.

13. The battery protection method according to claim 12, wherein the step of adjusting the charging voltage provided to the battery module according to the recommended charging voltage reduction value comprises:
during use of the battery module, adjusting the charging voltage by further reducing the corresponding recommended charging voltage reduction value based on the current recommended charging voltage value.

14. The battery protection method according to claim 13, further comprising:
when the stored power of the battery cell pack is less than a power threshold value, restoring the provided recommended charging voltage reduction value to 0, so that the charging voltage is restored to the recommended charging voltage value.

15. The battery protection method according to claim 9, further comprising:
when a battery cell voltage of the battery cell pack is greater than the charging voltage, turning on a self-discharging function.

16. The battery protection method according to claim 15, wherein the battery cell pack comprise a plurality of battery cells connected in series, the battery module further comprises a discharging circuit, and the battery protection method further comprises:
when the self-discharging function is turned on, establishing one or a plurality of discharging loops through the discharging circuit, so that the plurality of battery cells are discharged sequentially.
